(19) United States
(12) Patent Application Publication
(10) Pub. No.: US 2004/0242193 A1
(43) Pub. Date: Dec. 2, 2004

(54) Method and apparatus for billing for calls during roaming

(75) Inventor: Geza Olah, Budapest (HU)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 10/796,275

(22) Filed: Mar. 10, 2004

(30) Foreign Application Priority Data
Mar. 18, 2003 (DE) 103 119 63.9

(51) Int. Cl. H04M 11/00

(52) U.S. Cl. 455/406

(57) ABSTRACT

A method and apparatus is proposed in which, prior to setting up a connection, a caller is able to declare that he is prepared to accept roaming charges. In addition, prior to the connection being set up, the called party can reject the connection if the caller will not accept the charges.

This application claims the benefit of priority to German Application No. 10311963.9, filed in the German language on Mar. 18, 2003, the contents of which are hereby incorporated by reference.

### TECHNICAL FIELD OF THE INVENTION

The invention relates to billing for calls when the called party is in a foreign network.

### BACKGROUND OF THE INVENTION

In recent years, telephoning using mobile radio networks has made up a large share of the telephone market. Subscribers have since dispensed with previously customary landline access and are making use of the advantages afforded by mobile network access.

One advantage of the mobile network is that the subscriber can take his terminal with him at all times and (almost) everywhere. This means that he can continue to be reached on the known number even during holiday and business trips, provided that there is a “roaming agreement” between the mobile radio operator in whose network he is currently located and his own mobile radio operator.

This roaming is part of the GSM standard, and will also be an important feature of future generations of mobile telephony.

A distinction is drawn between “active roaming” and “passive roaming”. Passive roaming refers to when the called party “is roaming”, that is to say the B subscriber is outside of his home network, for example abroad. Accordingly, active roaming is when the caller is abroad.

One problem of roaming is the billing for such a call. The caller, who generally does not know where the called party is currently located, does not want to be charged the high foreign costs. For this reason, the network operator charges him only the normal domestic costs as a first billing share for the call, and the called party is charged the difference between the costs as a second billing share.

In other countries, in turn, it may be customary for the caller to have to bear the high costs (in full) himself. This method is inflexible. It is possible to imagine instances in which, although the called party wishes to be able to be reached, he is at the same time not prepared to bear the possibly high costs of roaming. This is the case, for example, when an employee needs to be able to be reached by the company on his private mobile phone number (including for emergencies while on holiday).

It may also be that the caller himself wishes to accept the roaming charges for the called party, for example parents who wish to reach their child on a school trip aboard but in so doing do not want to encumber the child's prepaid account with the additional roaming charges.

For various reasons, for example legal reasons, it should also not be possible simply to charge the caller the higher costs, however.

### SUMMARY OF THE INVENTION

In the invention, a called party can be reached as a roaming subscriber in a foreign network without additional charges.

The caller is thus able to reach subscribers who are abroad and would not be prepared or able to bear the roaming costs. They would otherwise presumably switch off their terminal or reject incoming calls from the home network.

This approach also provides advantages for the operator:

Additional chargeable connections arise. The call potential, calls for which the called party was previously not prepared to accept the additional costs are no longer lost.

If the service is provided on an operator basis, this is preferred to the terminal associated with a foreign operator, if there is one. The operator therefore earns from the sale of the terminals and agreements.

### BRIEF DESCRIPTION OF THE DRAWINGS

The invention is explained below using exemplary embodiments, in which:

FIG. 1 shows a flowchart of the inventive service in one embodiment.

FIG. 2 shows a flowchart of the inventive service in another embodiment.

FIG. 3 shows an overview of the communication between subscriber and customer care center.

### DETAILED DESCRIPTION OF THE INVENTION

An IN service is extended.

Case A: At the Request of the Called Party

For B subscribers (called parties) who have selected billing using a credit account, it is fulfilled using the “prepaid service” itself. In this case, the “MTC (Mobile Terminating Call)” part of the service's logic is extended. The service works regardless of whether the caller (A subscriber) has selected credit or invoice billing (prepaid or postpaid).

Since the MTC logic needs to resort to data both from the called party and from the caller, the service works in this case if the two subscribers are customers of the same operator.

The service feature is also conceivable for contractual customers. These are set up as IN subscribers, for example, if they are subscribers in a VPN (Virtual Private Network).

The service's data model needs to be extended by a field on a subscriber level, into which field a marking is entered which indicates that the subscriber permits passive roaming at the cost of the caller. This field can be set up either by Customer Care or by sending an appropriate USSD (Unstructured Supplementary Services Data) message. Optionally, the MTC tariff model may also be extended by a new matrix if the operator wants to include different charges for conventional passive roaming and for passive roaming at the cost of the caller.

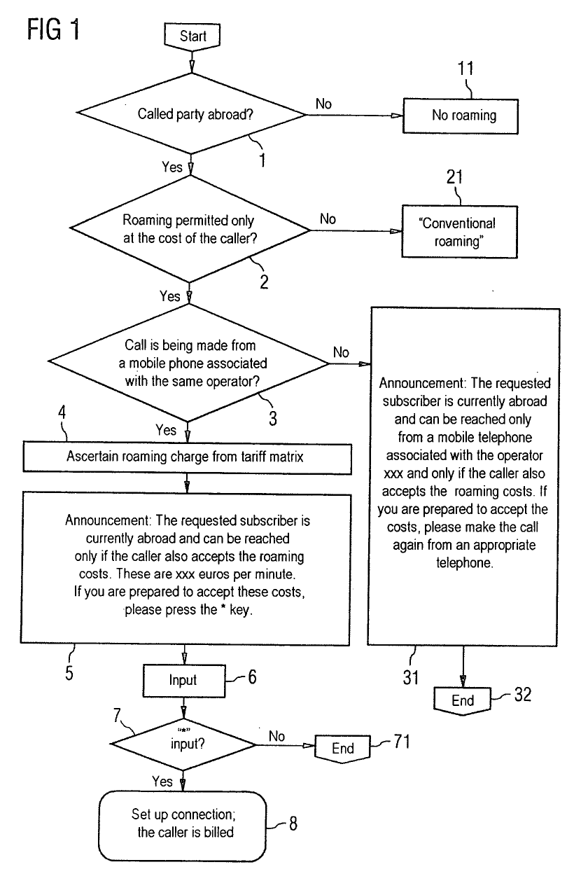

FIG. 1 shows, in the form of a flowchart, how the MTC (Mobile Terminating Call) logic of the prepaid service needs to be extended.

At the start of the logic, it is established whether the subscriber is abroad (“Called party abroad?”, 1). In this case, there is an additional check to determine whether this particular type of roaming has been set for the specific subscriber (“Roaming permitted only at the cost of the caller?”, 2). For this, a new SSD field can be provided in the MTC prototype, whose content is checked. Subsequently, this branch of the flowchart is handled (that is to say if the called subscriber is abroad and the caller has been entered as bearing the costs of the passive roaming), otherwise the service logic proceeds as previously in the case of “conventional roaming”.

Since the solution described here works in the case when the caller and the called party are customers of the same operator, it is necessary to check whether this is the case (“Call is being made from a mobile phone associated with the same operator”, 3). If the caller is calling from an access point associated with another operator (mobile network or landline network), he hears an announcement and the call is ended, 31. By way of example, the announcement informs the caller that the called subscriber is abroad and that he can be reached only from a mobile phone associated with the operator XY, at the cost of the caller. In this case, the caller is thus also informed about the option, and can attempt the call again if he has an appropriate mobile phone.

If the caller is calling from a mobile phone associated with the same operator, he is informed by an announcement that the call is possible if he also accepts the roaming charges (“The requested subscriber is currently abroad . . . ”. 5). The level of the charge can be selected from the MTC tariff matrix, and can also be communicated by an announcement.

The caller can then confirm, for example by pressing a key, that he accepts the roaming costs, 7. Following confirmation, the connection to the called party is actually set up, 8.

Billing is performed as follows: the roaming charges are determined from the tariff prototype's tariff matrix. It is also possible to define a dedicated matrix for this type of roaming. These charges are not debited from the called party's credit (prepaid) account (in the IN system), however, but instead the charges are debited from the caller's prepaid account if he is a prepaid subscriber. The MTC logic can also access the data from another subscriber. If he is a postpaid customer, then IN-AMA (Automatic Message Accounting) tickets are written for him.

CASE B: At the Request of the Caller

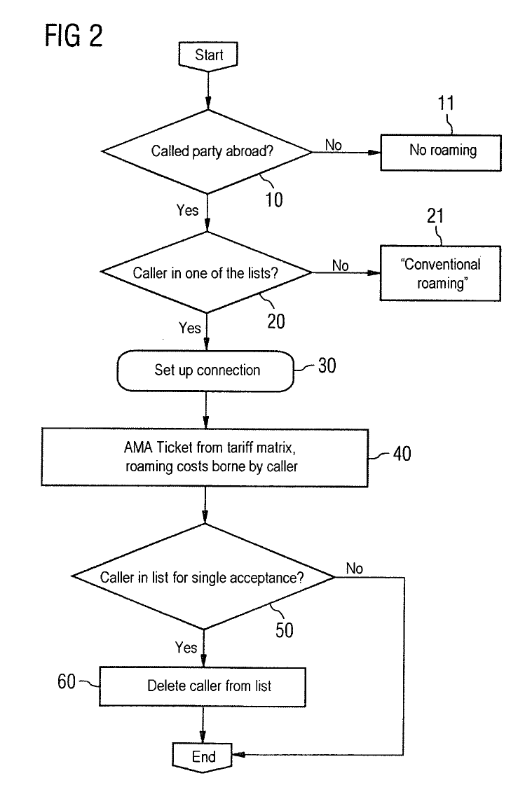

The IN service's data model is extended on the subscriber level by two lists. FIG. 2 shows, in the form of a flowchart, how the prepaid service's MTC (Mobile Terminating Call) logic needs to be extended.

The first list (List 1) includes the telephone number of the subscribers who have declared themselves prepared to accept the passive roaming charges for their own calls to this subscriber until revocation.

A second list (List 2) can be used to manage those subscribers who are prepared to do so for the next call. The caller is deleted from this list following a successful call setup.

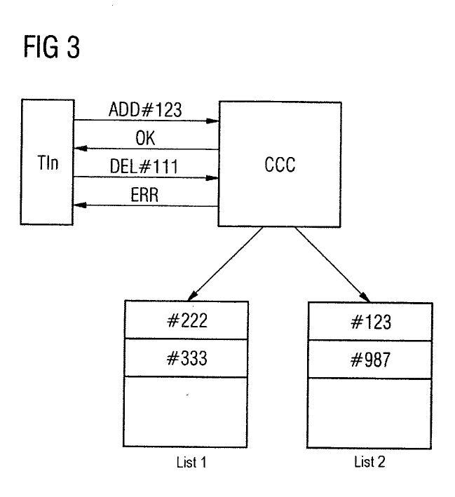

The exemplary setup of a data communication is shown in FIG. 3.

The two lists are managed most easily by USSD (Unstructured Supplementary Services Data) messages to a Customer Care Center (CCC). 3 access codes are defined:

the subscriber (Tln) can use the first message to declare himself prepared to accept the passive roaming charges for the next call (ADD);

the subscriber can use the second message to declare himself prepared to do so until revocation, and

the subscriber can use the third message to revoke the second message. The three messages have at least one parameter after the access code: the call number of the called party (DEL).

The service needs to be extended by the processing of these USSD messages. In the case of the first two messages, an entry is added to the appropriate list, and the entry is removed from the list in the case of the third. When this action has been performed successfully, confirmation can be sent (OK) to the mobile phone (likewise in the form of USSD). If there is an error (e.g. the requested subscriber does not exist as an IN subscriber), a corresponding response is also given (ERR).

The prepaid service's MTC (Mobile Terminating Call) logic needs to be extended as follows:

At the start of the logic, it is now also identified that the subscriber is abroad, 10. In this case, there needs to be an additional check to determine whether the caller is held in one of the two lists, 20. The call is then set up in both cases, 30, with the result of this check merely governing who bears the roaming costs. If this is the caller, then the roaming charges are not debited from the called party's prepaid account, but rather IN AMA tickets are written for the caller (if he is a postpaid subscriber), or the charges are debited from his prepaid account (if he is likewise a prepaid subscriber), 40. The level of the charges is ascertained from the tariff matrix of the tariff prototype. Optionally, this may also be a different tariff matrix than in the case of conventional roaming, (if the operator wishes to include different charges for conventional passive roaming and for passive roaming at the cost of the caller).

If the caller is held in the list indicating a wish to accept charges for one call only, the caller is deleted from the list following successful call setup, 60.

What is claimed is:

1. A method for billing for a connection from a first subscriber in a first communication network to a second subscriber in a second communication network which is connected to the first communication network, comprising:
providing a level of the billing of a first billing share for the connection in the first communication network and a second billing share for the connection in the second communication network; and
setting up a connection if the first subscriber accepts both billing shares.

2. The method as claimed in claim 1, wherein prior to connection setup, the second subscriber stores information not to accept the billing share for the second communication network.

3. The method as claimed in claim 2, wherein
when setting up a connection, the first subscriber is asked to accept the billing share for the second communication network, and
the connection to the second subscriber is set up if the first subscriber responds affirmatively.

4. The method as claimed in claim 1, wherein
prior to connection setup, the first subscriber stores information to accept the billing share for the second communication network.

5. The method as claimed in claim 4, wherein
the first subscriber accepts the billing share for the second communication network for at least one connection setup.

6. The method as claimed in claim 4, wherein
the first subscriber can retract the agreement to accept the billing share for the second communication network.

7. An apparatus in a first communication network, comprising:
a memory to store information that a subscriber is not prepared to accept a billing share for a second communication network when an incoming connection is set up.

8. An apparatus in a first communication network, comprising:
a first memory to store information that a subscriber is prepared to accept a billing share for a second communication network when an outgoing connection is set up; and
a second memory to store the information that the subscriber is prepared to accept the billing share for the second communication network when an outgoing connection is set up.
